(19) United States
(12) Patent Application Publication
(10) Pub. No.: US 2023/0180340 A1
(43) Pub. Date: Jun. 8, 2023

(54) METHOD AND APPARATUS FOR SMALL DATA TRANSMISSION

(71) Applicant: Lenovo (Beijing) Ltd., Beijing (CN)

(72) Inventors: Ran Yue, Haidian District (CN); Lianhai Wu, Chaoyang (CN); Jing Han, Chaoyang District (CN); Haiming Wang, Xicheng District (CN); Jie Shi, Haidian District (CN); Jie Hu, Changping District (CN); Jianning Liu, Haidian District (CN)

(73) Assignee: Lenovo (Beijing) Ltd., Beijing (CN)

(21) Appl. No.: 17/910,956

(22) PCT Filed: Mar. 13, 2020
(86) PCT No.: PCT/CN2020/079330

§ 371 Date: Sep. 12, 2022

(51) Int. Cl. H04W 76/27; H04L 1/1812

(52) U.S. Cl. CPC H04W 76/27; H04L 1/1812

(57) ABSTRACT

The present application relates to a user equipment, a base station, and a method for small data transmission. The base station transmits configuration information of small data transmission to the user equipment. The user equipment receives the configuration information of small data transmission from the base station. The user equipment and the base station perform small data transmission based on the configuration information.

### TECHNICAL FIELD

The present disclosure generally relates to data transmission, and relates more particularly to small data transmission.

### BACKGROUND OF THE INVENTION

In conventional network, different services (e.g., different applications) between base station and user equipment may be performed with different types of data transmissions. Specifically, part of the services may be performed with normal data transmission while part of the service may be performed with small data transmission. However, specific details for base station and user equipment to distinguish whether a service can be performed with small data transmission have not been discussed yet and there are still some issues that need to be solved.

### BRIEF SUMMARY OF THE INVENTION

One embodiment of the present disclosure provides a method of a user equipment. The method includes: receiving configuration information of small data transmission from a base station; and performing at least one small data transmission with the base station according to the configuration information of small data transmission.

Another embodiment of the present disclosure provides a method of a base station. The method includes: transmitting configuration information of small data transmission to a user equipment; and performing at least one small data transmission with the user equipment according to the configuration information of small data transmission.

Yet another embodiment of the present disclosure provides an apparatus. According to an embodiment of the present disclosure, the apparatus includes: at least one non-transitory computer-readable medium having computer executable instructions stored therein; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions are configured to, with the at least one processor, cause the apparatus to perform a method according to an embodiment of the present disclosure.

### BRIEF DESCRIPTION OF THE DRAWINGS

In order to describe the manner in which advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a wireless communication system according to an embodiment of the present disclosure.

FIG. 2 illustrates data transmission in a wireless communication system according to an embodiment of the present disclosure.

FIGS. 3A to 3C are schematic views of message transmission among a wireless communication system according to an embodiment of the present disclosure.

FIGS. 4A to 4C are schematic views of message transmission among a wireless communication system according to an embodiment of the present disclosure.

FIGS. 5A to 5C are schematic views of message transmission among a wireless communication system according to an embodiment of the present disclosure.

FIGS. 6A to 6C are schematic views of message transmission among a wireless communication system according to an embodiment of the present disclosure.

FIG. 7 illustrates a flow chart of a method for wireless communications according to an embodiment of the present disclosure.

FIGS. 8A to 8C illustrate flow charts of a method for wireless communications according to an embodiment of the present disclosure.

FIG. 9 illustrates a flow chart of a method for wireless communications according to an embodiment of the present disclosure.

FIG. 10 illustrates an example block diagram of an apparatus according to an embodiment of the present disclosure.

### DETAILED DESCRIPTION OF THE INVENTION

The detailed description of the appended drawings is intended as a description of preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

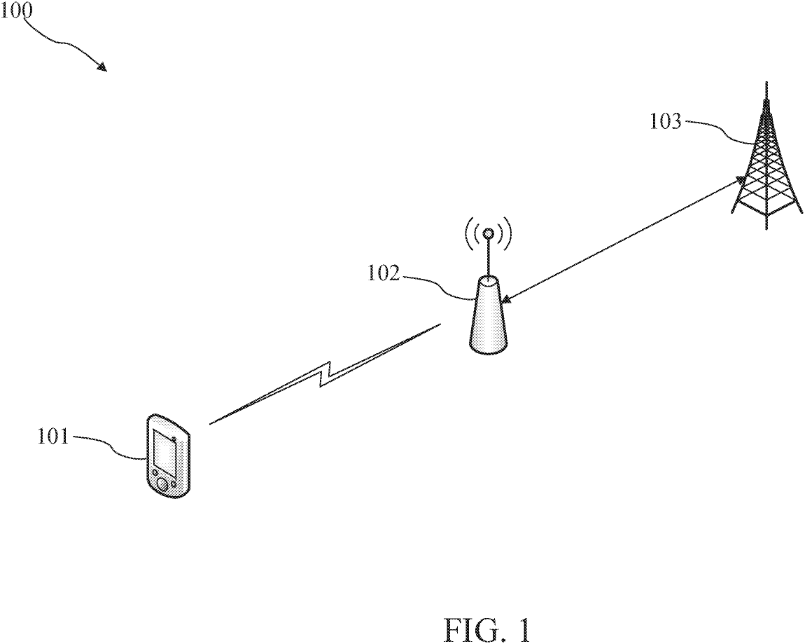

Referring to FIG. 1, a wireless communication system 100 may include a user equipment (UE) 101, a base station (BS) 102 and a core network (CN) 103. Although a specific number of UE 101, BS 102 and CN 103 are depicted in FIG. 1, it is contemplated that any number of UEs 101, BSs 102 and CNs 103 may be included in the wireless communication system 100.

CN 103 may include a core Access and Mobility management Function (AMF) entity. BS 102, which may communicate with CN 103, may operate or work under the control of the AMF entity. CN 103 may further include a User Plane Function (UPF) entity, which communicatively coupled with the AMF entity.

BS 102 may be distributed over a geographic region. In certain embodiments of the present application, BS 102 may also be referred to as an access point, an access terminal, a base, a base unit, a macro cell, a Node-B, an evolved Node B (eNB), a gNB, a Home Node-B, a relay node, or a device, or described using other terminology used in the art. BS 102 is generally part of a radio access network that may include one or more controllers communicably coupled to one or more corresponding BS(s).

UE 101 may include, for example, but is not limited to, computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), Internet of Thing (IoT) devices, or the like.

According to some embodiments of the present application, UE 101 may include, for example, but is not limited to, a portable wireless communication device, a smart phone, a cellular telephone, a flip phone, a device having a subscriber identity module, a personal computer, a selective call receiver, or any other device that is capable of sending and receiving communication signals on a wireless network.

In some embodiments of the present application, UE 101 may include, for example, but is not limited to, wearable devices, such as smart watches, fitness bands, optical head-mounted displays, or the like. Moreover, UE 101 may be referred to as a subscriber unit, a mobile, a mobile station, a user, a terminal, a mobile terminal, a wireless terminal, a fixed terminal, a subscriber station, a user terminal, or a device, or described using other terminology used in the art. UE 101 may communicate directly with BS 102 via uplink communication signals.

The wireless communication system 100 may be compatible with any type of network that is capable of sending and receiving wireless communication signals. For example, the wireless communication system 100 is compatible with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, a Long Term Evolution (LTE) network, a 3GPP-based network, a 3GPP 5G network, a satellite communications network, a high altitude platform network, and/or other communications networks.

In some embodiments of the present application, the wireless communication system 100 is compatible with the 5G New Radio (NR) of the 3GPP protocol or the 5G NR-light of the 3GPP protocol, wherein BSs 102 transmit data using an OFDM modulation scheme on the downlink (DL) and UE 101 transmit data on the uplink (UL) using a single-carrier frequency division multiple access (SC-FDMA) or OFDM scheme. More generally, however, the wireless communication system 100 may implement some other open or proprietary communication protocols, for example, WiMAX, among other protocols.

In some embodiments of the present application, BS 102 may communicate using other communication protocols, such as the IEEE 802.11 family of wireless communication protocols. Further, in some embodiments of the present application, BS 102 may communicate over licensed spectrums, whereas in other embodiments BS 102 may communicate over unlicensed spectrums. The present application is not intended to be limited to the implementation of any particular wireless communication system architecture or protocol. In yet some embodiments of present application, BS 102 may communicate with UE 101 using the 3GPP 5G protocols.

In some existed agreements, small data transmission may be introduced in the wireless communication system 100 to improve efficiency of data transmission between UE 101 and BS 102. However, specific details for base station and user equipment to distinguish whether a service (e.g., an application) can be performed with small data transmission have not been discussed yet and there are still some issues that need to be solved.

In some embodiments, because one Data Radio Bearer (DRB) may correspond to one service (e.g., one application), configuring different DRBs to transmit data as different data transmissions (i.e., small data transmission or normal data transmission) may be used to distinguish the different data transmissions (i.e., small data transmission or normal data transmission) of the corresponding services. Particularly, when a DRB between UE 101 and BS 102 is configured to allow small data transmission (i.e., small data transmission is allowed to be perform by the DRB), a service corresponding to the DRB may be performed with small data transmission. In some embodiments, because one Logical CHannel (LCH) may correspond to one DRB, configuring different LCHs to transmit data as different data transmissions may be used to distinguish the different data transmissions of the corresponding DRBs and further to distinguish the different data transmissions of the corresponding services.

Accordingly, for distinguishing whether service (e.g., application) can be performed with small data transmission, BS 102 may determine configuration information 102C of small data transmission while the configuration information 102C may be used to configure at least one DRB/LCH for at least one small data transmission between UE 101 and BS 102. In other words, the configuration information 102C may indicate to UE 101 which DRB(s)/LCH(s) between UE 101 and BS 102 is (are) allowed for small data transmission in a pre-configured uplink resource (e.g., Physical Uplink Shared Channel, PUSCH).

In addition, in some implementations, BS 102 may determine the configuration information 102C of small data transmission while the configuration information 102C may be used to configure to resume the at least one DRB/LCH for at least one small data transmission between UE 101 and BS 102. In other words, the configuration information 102C may indicate to UE 101 which DRB(s)/LCH(s) between UE 101 and BS 102 is (are) allowed to be resumed for small data transmission in the pre-configured uplink resource.

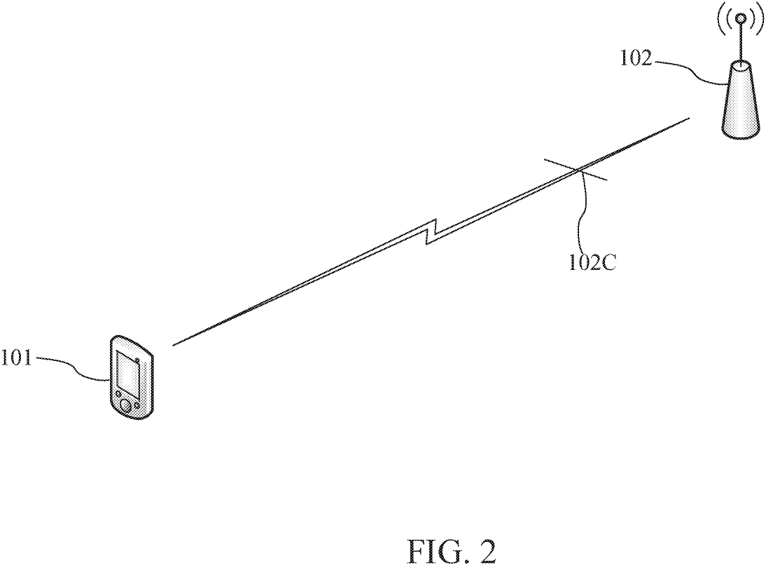

Referring to FIG. 2, after determining the configuration information 102C, BS 102 may transmit the configuration information 102C to UE 101. Subsequently, UE 101 may receive the configuration information 102C form BS 102. UE 101 may then store the configuration information 102C for later use.

In some embodiments, small data transmission may be performed while UE 101 is in an inactive state. Therefore, when UE 101 is entering the inactive state (e.g., from a connected state), UE 101 may apply the configuration information 102C for being configured which DRB(s)/LCH(s) between UE 101 and BS 102 is (are) allowed for small data transmission in the pre-configured uplink resource.

Accordingly, while UE 101 is in the inactive state and data on DRB/LCH arrives (i.e., the data is ready for being further processed), UE 101 may determine whether the DRB/LCH is configured (i.e., is allowed) for small data transmission. If the DRB/LCH is configured (i.e., is allowed) for small data transmission, UE 101 may perform small data transmission to transmit the data to BS 102 by the DRB/LCH. In other words, UE 101 may transmit the data as small data transmission to BS 102 by the DRB/LCH.

If the DRB/LCH is not configured (i.e., is not allowed) for small data transmission, UE 101 may not perform small data transmission to transmit the data to BS 102 by the DRB/LCH. Further, in some implementations, while the DRB/LCH is not configured (i.e., is not allowed) for small data transmission, UE 101 may enter a connected state and perform normal data transmission to transmit the data to BS 102 by the DRB/LCH.

In some embodiments, the configuration information 102C may be transmitted during a Radio Resource Control (RRC) procedure between UE 101 and BS 102. More specifically, the configuration information 102C may be transmitted with an RRC message from BS 102 to UE 101 during the corresponding RRC procedure.

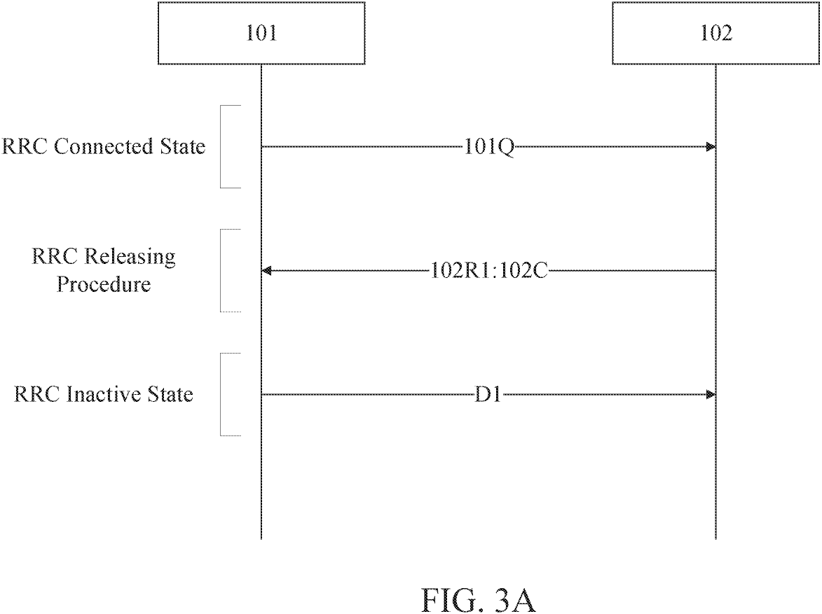

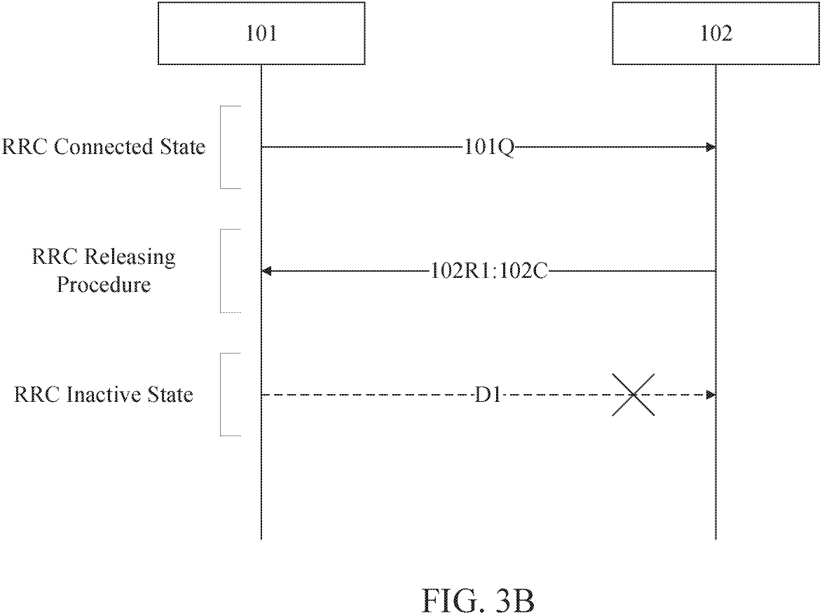

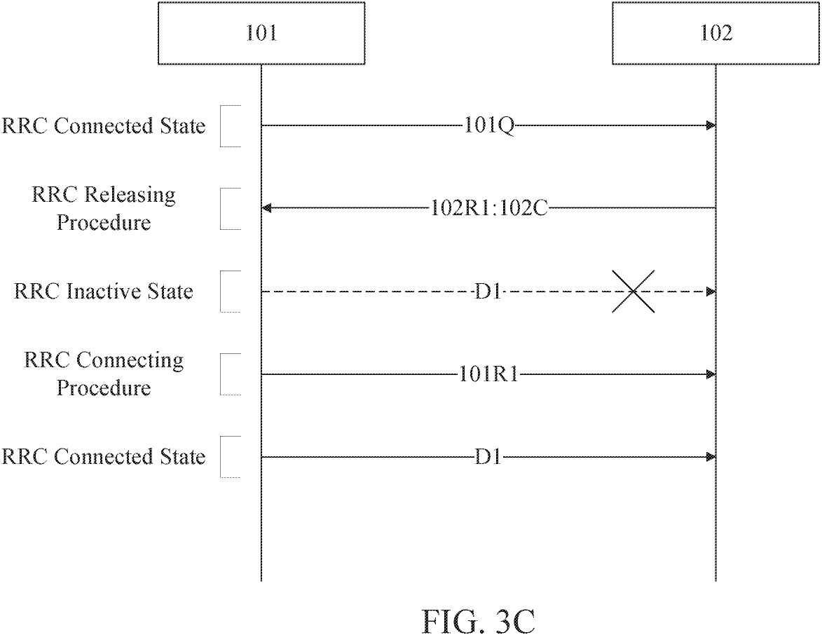

In some embodiments, the configuration information 102C may be transmitted with an RRC release message from BS 102 to UE 101 during an RRC release procedure. Please refer to FIG. 3A. In detail, while UE 101 is in the connected state by an RRC connection, UE 101 may transmit a request 101Q to BS 102. The request 101Q may be used for requesting the configuration information 102C for small data transmission when UE 101 is in the inactive state. After receiving the request 101Q, BS 102 may determine the configuration information 102C according to the request 101Q.

Next, when the RRC connection between UE 101 and BS 102 needs to be released, BS 102 may transmit an RRC message 102R1 (e.g., RRCConnectionRelease) to UE 101. The configuration information 102C may be included in the RRC message 102R1. Then, after receiving the RRC message 102R1, UE 101 may retrieve the configuration information 102C from the RRC message 102R1 and store the configuration information 102C. Further, UE 101 may apply the configuration information 102C once UE 101 enters the inactive state. In some implementations, UE 101 may store the configuration information 102C as an UE Access Stratum (AS) context.

Accordingly, while UE 101 is in the inactive state and data D1 on the DRB/LCH arrives, UE 101 may determine whether the DRB/LCH is configured (i.e., is allowed) for small data transmission. If the DRB/LCH is configured (i.e., is allowed) for small data transmission, UE 101 may perform small data transmission to transmit the data D1 to BS 102 by the DRB/LCH. In other words, UE 101 may transmit the data D1 as small data transmission to BS 102 by the DRB/LCH. In some implementations, UE 101 may resume the DRB/LCH first, and then perform small data transmission to transmit the data D1 to BS 102 by the DRB/LCH.

Please refer to FIG. 3B. If the DRB/LCH is not configured (i.e., is not allowed) for small data transmission, UE 101 may not perform small data transmission to transmit the data D1 to BS 102 by the DRB/LCH (as depicted as the dotted line). Further, please refer to FIG. 3C. In some implementations, while the DRB/LCH is not configured (i.e., is not allowed) for small data transmission, UE 101 may transmit an RRC message 101R1 (e.g., RRCConnectionResumeRequest or RRCConnectionRequest) for entering a connected state and perform normal data transmission to transmit the data D1 to BS 102 by the DRB/LCH in the connected state.

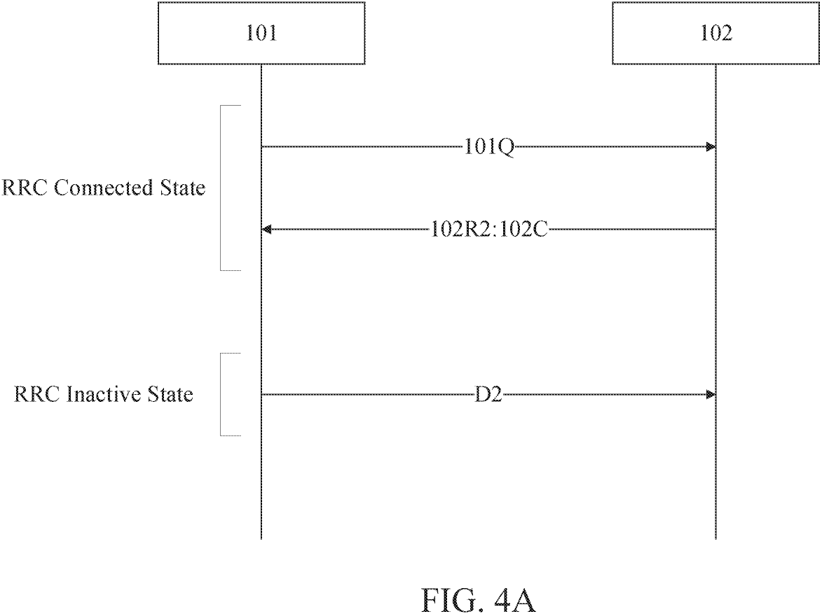

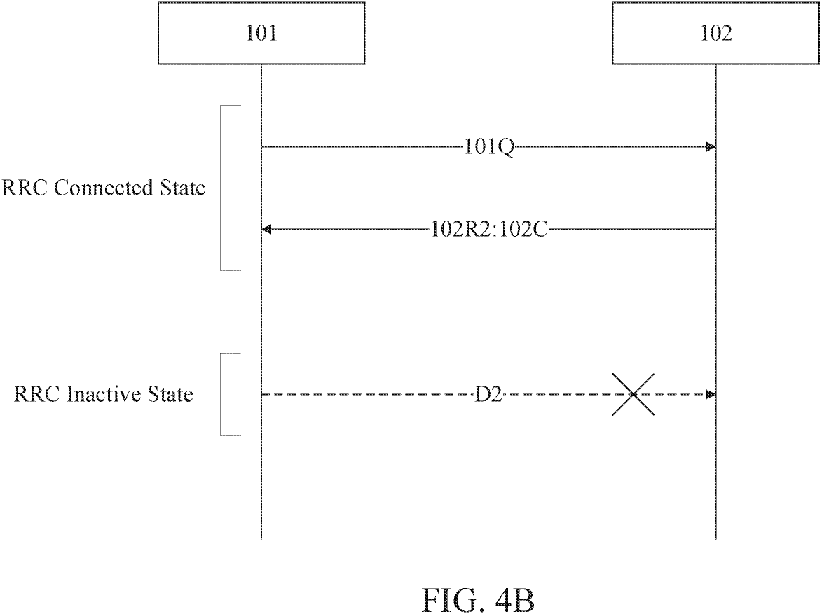

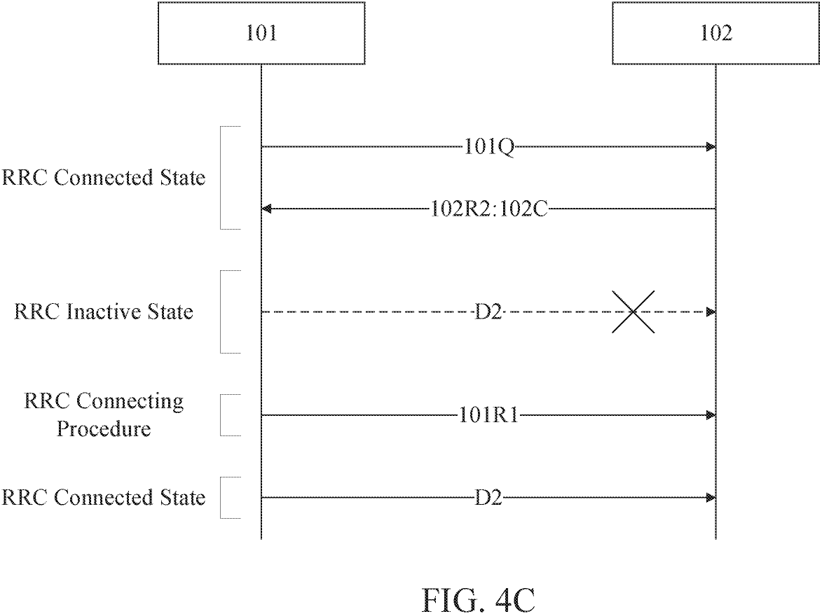

In some embodiments, the configuration information 102C may be transmitted with an RRC configuration message from BS 102 to UE 101 in the RRC connected state. Please refer to FIG. 4A. In detail, while UE 101 is in the connected state by the RRC connection, UE 101 may transmit the request 101Q to BS 102. The request 101Q may be used for requesting the configuration information 102C for small data transmission when UE 101 is in the inactive state. After receiving the request 101Q, BS 102 may determine the configuration information 102C according to the request 101Q.

Next, BS 102 may transmit an RRC message 102R2 (e.g., RRCConfiguration) to UE 101 in the RRC connected state. The configuration information 102C may be included in the RRC message 102R2. Then, after receiving the RRC message 102R2, UE 101 may retrieve the configuration information 102C from the RRC message 102R2 and store the configuration information 102C. Further, UE 101 may apply the configuration information 102C once UE 101 enters the inactive state. In some implementations, UE 101 may store the configuration information 102C as an UE AS context.

Accordingly, while UE 101 is in the inactive state and data D2 on the DRB/LCH arrives, UE 101 may determine whether the DRB/LCH is configured (i.e., is allowed) for small data transmission. If the DRB/LCH is configured (i.e., is allowed) for small data transmission, UE 101 may perform small data transmission to transmit the data D2 to BS 102 by the DRB/LCH. In other words, UE 101 may transmit the data D2 as small data transmission to BS 102 by the DRB/LCH. In some implementations, UE 101 may resume the DRB/LCH first, and then perform small data transmission to transmit the data D2 to BS 102 by the DRB/LCH.

Please refer to FIG. 4B. If the DRB/LCH is not configured (i.e., is not allowed) for small data transmission, UE 101 may not perform small data transmission to transmit the data D2 to BS 102 by the DRB/LCH (as depicted as the dotted line). Further, please refer to FIG. 4C. In some implementations, while the DRB/LCH is not configured (i.e., is not allowed) for small data transmission, UE 101 may transmit the RRC message 101R1 (e.g., RRCConnectionResumeRequest or RRCConnectionRequest) for entering the connected state and perform normal data transmission to transmit the data D2 to BS 102 by the DRB/LCH in the connected state.

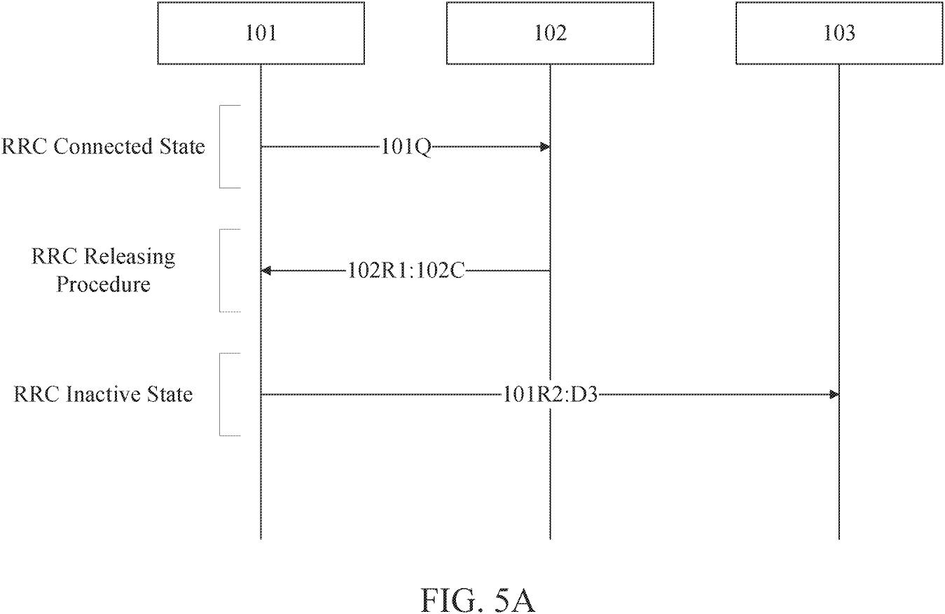

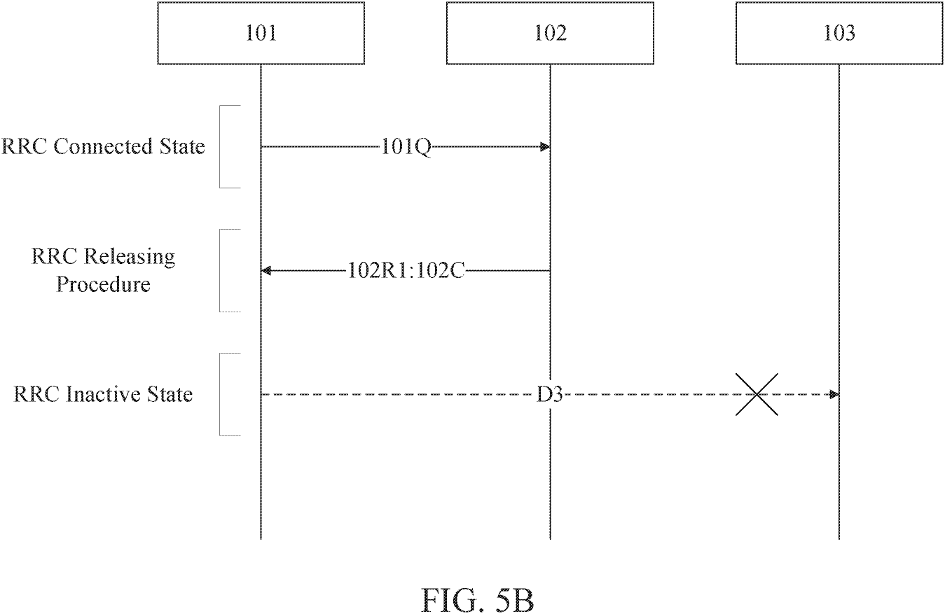

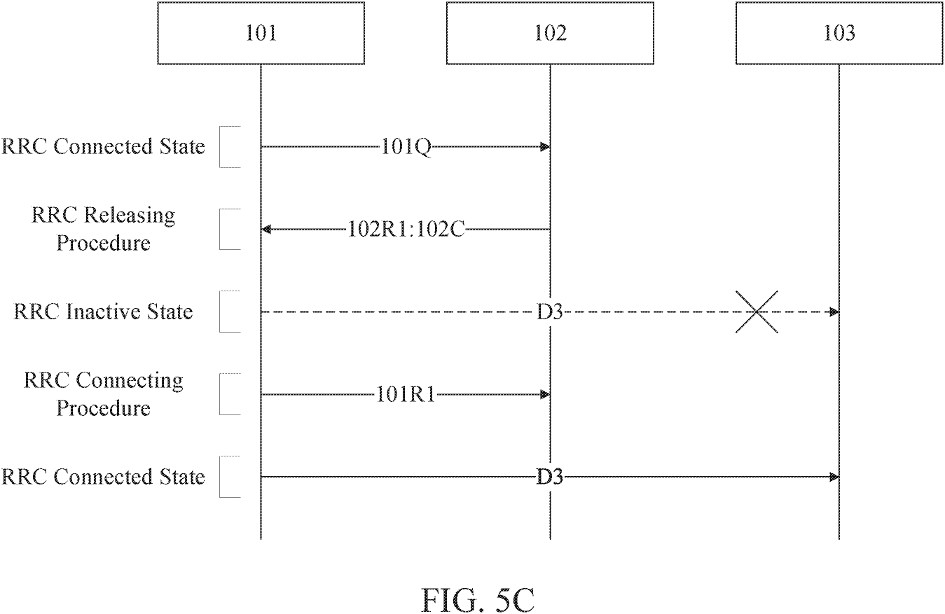

In some embodiments, the configuration information 102C may be transmitted with the RRC release message from BS 102 to UE 101 during the RRC release procedure and data for small data transmission may be transmitted to CN 103 via BS 102 according to mapping relation between flow (e.g., QoS flow) and DRB/LCH. Please refer to FIG. 5A. In detail, while UE 101 is in the connected state by the RRC connection, UE 101 may transmit the request 101Q to BS 102. The request 101Q may be used for requesting the configuration information 102C for small data transmission when UE 101 is in the inactive state. After receiving the request 101Q, BS 102 may determine the configuration information 102C according to the request 101Q.

Next, when the RRC connection between UE 101 and BS 102 needs to be released, BS 102 may transmit the RRC message 102R1 (e.g., RRCConnectionRelease) to UE 101. The configuration information 102C may be included in the RRC message 102R1. Then, after receiving the RRC message 102R1, UE 101 may retrieve the configuration information 102C from the RRC message 102R1 and store the configuration information 102C. Further, UE 101 may apply the configuration information 102C once UE 101 enters the inactive state. In some implementations, UE 101 may store the configuration information 102C as the UE AS context.

In some embodiments, after applying the configuration information 102C, UE 101 may identify a mapping relation between flow(s) and the configured (e.g., allowed) DRB(s)/LCH(s). Then, according to the mapping relation, a lower layer (e.g., AS layer) of UE 101 may indicate to a higher layer (e.g., Non-Access Stratum layer, NAS layer) of UE 101 that the flow(s), which corresponds the configured (i.e., allowed) DRB(s)/LCH(s), may be used for the small data transmission.

In some implementations, the mapping relation may indicate which DRB/LCH that one flow corresponds to. More specifically, one DRB/LCH may include one or more than one flow, and the mapping relation may record the corresponding DRB/LCH for each flow. For example, when DRB/LCH “X” includes one flow “x” (i.e., flow “x” corresponds to DRB/LCH “X”), the mapping relation may indicate that flows “x” corresponds to DRB/LCH “X”. For another example, when DRB/LCH “A” includes two flows “a” and “b” (i.e., two flows “a” and “b” correspond to DRB/LCH “A”), the mapping relation may indicate that flows “a” corresponds to DRB/LCH “A” and flows “b” corresponds to DRB/LCH “A”.

Accordingly, while UE 101 is in the inactive state and data D3 on the flow arrives, UE 101 may determine whether the flow maps to the configured DRB/LCH based on the mapping relation. If the flow maps to the configured (i.e., allowed) DRB/LCH for small data transmission, UE 101 may perform small data transmission to transmit the data D3 to CN 103 via BS 102 with an RRC message 101R2 or with a higher layer (e.g., NAS layer) message (not shown). In other words, UE 101 may transmit the data D3 as small data transmission to CN 103 via BS 102 with the RRC message 101R2 or with the higher layer message.

Please refer to FIG. 5B. If the flow corresponds to the DRB/LCH which is not configured (i.e., is not allowed) for small data transmission, UE 101 may not perform small data transmission to transmit the data D3 to CN103. Further, please refer to FIG. 5C. In some implementations, while the flow corresponds to the DRB/LCH which is not configured (i.e., is not allowed) for small data transmission, UE 101 may transmit the RRC message 101R1 (e.g., RRCConnectionResumeRequest or RRCConnectionRequest) for entering the connected state and perform normal data transmission to transmit the data D3 to CN 103 via BS 102 by the flow within the corresponding DRB/LCH in the connected state.

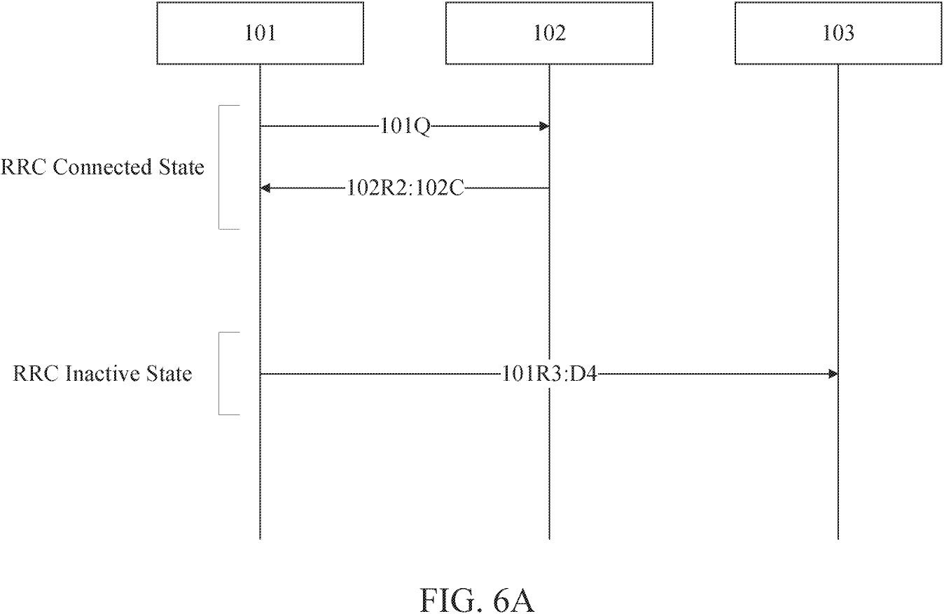

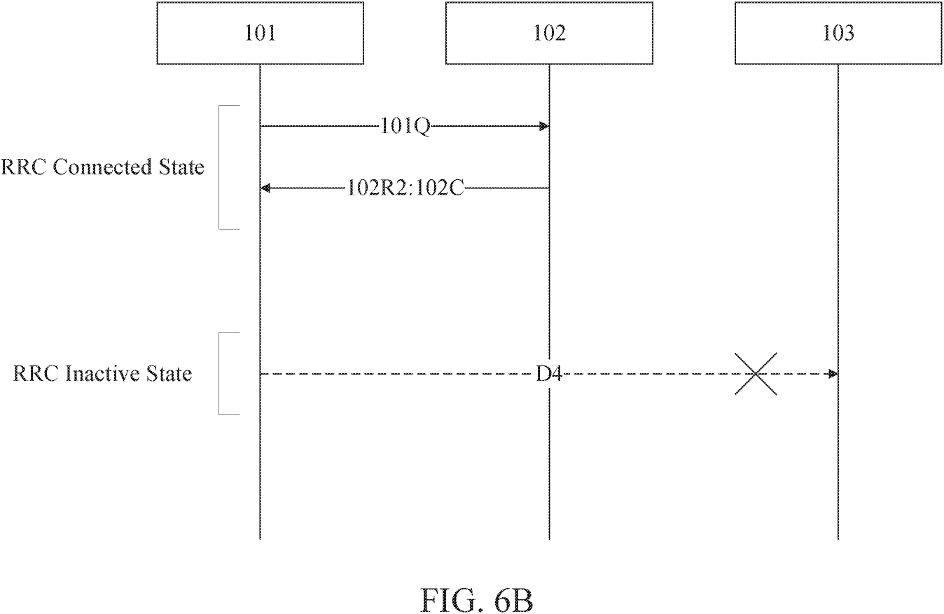

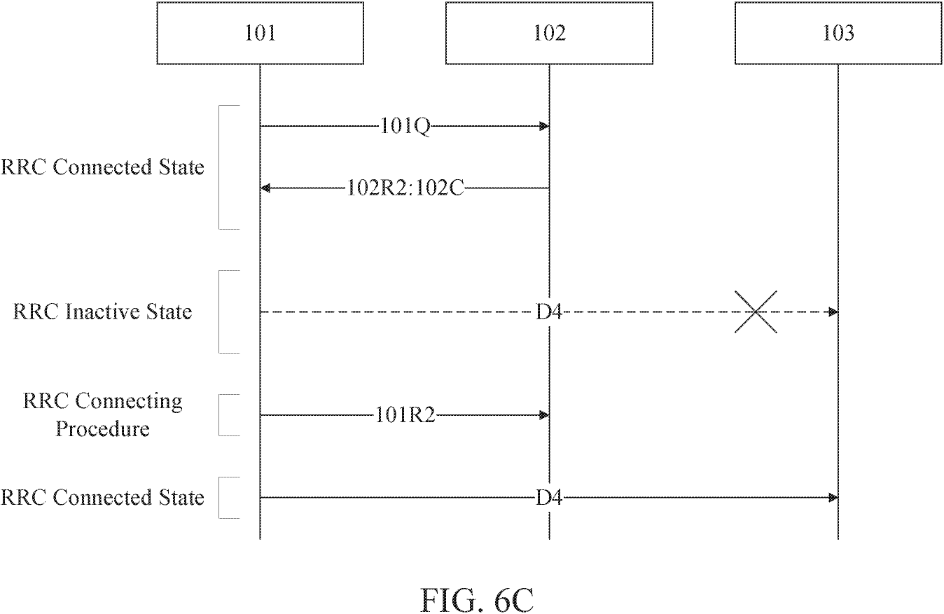

In some embodiments, the configuration information 102C may be transmitted with the RRC configuration message from BS 102 to UE 101 in the RRC connected state and data for small data transmission may be transmitted to CN 103 via BS 102 according to mapping relation between flow (e.g., QoS flow) and DRB/LCH. Please refer to FIG. 6A. In detail, while UE 101 is in the connected state by the RRC connection, UE 101 may transmit the request 101Q to BS 102. The request 101Q may be used for requesting the configuration information 102C for small data transmission when UE 101 is in the inactive state. After receiving the request 101Q, BS 102 may determine the configuration information 102C according to the request 101Q.

Next, BS 102 may transmit the RRC message 102R2 (e.g., RRCConfiguration) to UE 101 in the RRC connected state. The configuration information 102C may be included in the RRC message 102R2. Then, after receiving the RRC message 102R2, UE 101 may retrieve the configuration information 102C from the RRC message 102R2 and store the configuration information 102C. Further, UE 101 may apply the configuration information 102C once UE 101 enters the inactive state. In some implementations, UE 101 may store the configuration information 102C as an UE AS context.

In some embodiments, after applying the configuration information 102C, UE 101 may identify a mapping relation between flow(s) and the configured (e.g., allowed) DRB(s)/LCH(s). Then, according to the mapping relation, a lower layer (e.g., AS layer) of UE 101 may indicate to a higher layer (e.g., Non-Access Stratum layer, NAS layer) of UE 101 that the flow(s), which corresponds the configured (i.e., allowed) DRB(s)/LCH(s), may be used for the small data transmission.

Accordingly, while UE 101 is in the inactive state and data D4 on the flow arrives, UE 101 may determine whether the flow maps to the configured DRB/LCH based on the mapping relation. If the flow maps to the configured (i.e., allowed) DRB/LCH for small data transmission, UE 101 may perform small data transmission to transmit the data D4 to CN 103 via BS 102 with the RRC message 101R2 or with the higher layer (e.g., NAS layer) message (not shown). In other words, UE 101 may transmit the data D4 as small data transmission to CN 103 via BS 102 with the RRC message 101R2 or with the higher layer message.

Please refer to FIG. 6B. If the data D4 on the flow f corresponds to the DRB/LCH which is not configured (i.e., is not allowed) for small data transmission, UE 101 may not perform small data transmission to transmit the data D4 to CN103. Further, please refer to FIG. 6C. In some implementations, while the flow corresponds to the DRB/LCH which is not configured (i.e., is not allowed) for small data transmission, UE 101 may transmit the RRC message 101R1 (e.g., RRCConnectionResumeRequest or RRCConnectionRequest) for entering the connected state and perform normal data transmission to transmit the data D4 to CN 103 via BS 102 by the flow within the corresponding DRB/LCH in the connected state.

In some embodiments, a condition may be further applied to UE 101 for determining whether small data transmission can be performed. Particularly, if the condition is satisfied, the small data transmission may be performed. If the condition is not satisfied, the small data transmission may not be performed even the corresponding DRB/LCH is configured (i.e., is allowed) for small data transmission.

In some implementations, the condition may relate to size of Media Access Control (MAC) Protocol Data Unit (PDU). In detail, when there is/are configured (i.e., allowed) DRB(s)/LCH(s) for small data transmission and data under-transmitted by the configured DRB(s)/LCH(s) is resulted in a MAC PDU, UE 101 may determine whether a size of the MAC PDU is greater than a threshold “T1”.

If the MAC PDU is greater than the threshold “T1”, UE 101 may not perform small data transmission for the data on the preconfigured uplink resource. In other words, UE 101 may not transmit the data as small data transmission on the preconfigured uplink resource. If the MAC PDU is not greater than the threshold “T1”, UE 101 may perform small data transmission for the data on the preconfigured uplink resource. In other words, UE 101 may transmit the data as small data transmission on the preconfigured uplink resource.

In some embodiments, when the MAC PDU is determined greater than the threshold “T1”, UE 101 may re-generate a new MAC PDU for data under-transmitted by the configured DRB(s)/LCH(s), and adjust parameter for making a size of the new MAC PDU not to be greater than the threshold “T1”.

In some implementations, the condition may relate to buffered data size of Radio Link Control (RLC) or Packet Data Convergence Protocol (PDCP) transmission entity. In detail, for each RLC/PDCP transmission entity, which corresponds to one of the configured (i.e., allowed) DRB(s)/LCH(s), UE 101 may determine whether a current buffered data size of the RLC/PDCP transmission entity is greater than a threshold “T2”.

If the current buffered data size of the RLC/PDCP transmission entity is greater than the threshold “T2”, UE 101 may not perform small data transmission for the data by the corresponding DRB/LCH on the preconfigured uplink resource. In other words, UE 101 may not transmit the data as small data transmission by the corresponding DRB/LCH on the preconfigured uplink resource. If the current buffered data size of the RLC/PDCP transmission entity is not greater than the threshold “T2”, UE 101 may perform small data transmission for the data by the corresponding DRB/LCH on the preconfigured uplink resource. In other words, UE 101 may transmit the data as small data transmission by the corresponding DRB/LCH on the preconfigured uplink resource.

It should be noted that the LCH with higher priority may be used before the LCH with lower priority. Accordingly, in some implementations, the condition may relate to priority of LCH. In detail, UE 101 may determine whether a priority of the selected LCH is greater than a priority threshold. If the priority of the selected LCH is higher than the priority threshold, UE 101 may perform small data transmission for the data by the corresponding DRB/LCH on the preconfigured uplink resource. In other words, UE 101 may transmit the data as small data transmission by the corresponding DRB/LCH on the preconfigured uplink resource. If the priority of the selected LCH is not higher than the priority threshold, UE 101 may not perform small data transmission by the corresponding DRB/LCH.

In some embodiments, a Hybrid Automatic Repeat reQuest (HARQ) process may be applied to the data of small data transmission between UE 101 and BS 102 for checking the correctness of the transmission. If UE 101 determines that the data of small data transmission is not successfully transmitted to BS 102 on the PUSCH according to the HARQ process and function of autonomous re-transmission is enabled, UE 101 may autonomously re-transmit the data of small data transmission to NS 102 on the PUSCH.

In some embodiments, the configuration information 102C may indicate a restriction of selecting LCHs for each preconfigured uplink resource for small data transmission. Therefore, after receiving the configuration information 102C, UE 101 may add the restriction of selecting LCHs for each preconfigured uplink resource for small data transmission. Then, UE 101 may determine whether LCH(s) is (are) configured to be allowed to transmit data as small data transmission via the preconfigured uplink resource.

According to the restriction, if UE 101 determines that one LCH is available to transmit data as small data transmission via the preconfigured uplink resource, UE 101 transmits the data as small data transmission on the LCH. According to the restriction, if UE 101 determines that one LCH is not allowed to transmit data as small data transmission via the preconfigured uplink resource, UE 101 does not transmit the data as small data transmission on the LCH. In some embodiments, the restriction may be configured as a Logical Channel Prioritization (LCP) restriction.

For example, according to 3GPP specification #38.321, the LCP restriction may be described as follow:
1> select the logical channels for each UL grant that satisfy all the following conditions:
   2>the set of allowed Subcarrier Spacing index values in allowedSCS-List, if configured, includes the Subcarrier Spacing index associated to the UL grant; and
   2>maxPUSCH-Duration, if configured, is larger than or equal to the PUSCH transmission duration associated to the UL grant; and
   2>configuredGrantType1Allowed, if configured, is set to true in case the UL grant is a Configured Grant Type 1; and
   2>allowedServingCells, if configured, includes the Cell information associated to the UL grant. Does not apply to logical channels associated with a DRB configured with PDCP duplication within the same MAC entity (i.e. CA duplication) for which PDCP duplication is deactivated.

In some implementations of restriction of selecting LCHs for each preconfigured uplink resource for small data transmission, a new restriction as follow may be introduced:

2>smallDataAllowed, if configured, is set to true in case the UL grant is a Configured Grant for small data transmission.

It should be noted that “smallDataAllowed” may be a term used for representing a parameter for enabling/disabling small data transmission. For example, when value of “smallDataAllowed” is “0”, it means that small data transmission is disabled (i.e., is not allowed). When value of “smallDataAllowed” is “1”, it means that small data transmission is enabled (i.e., is allowed). For another example, when string of “smallDataAllowed” is “no”, it means that small data transmission is disabled (i.e., is not allowed). When string of “smallDataAllowed” is “yes”, it means that small data transmission is enabled (i.e., is allowed). In some implementations, the term used for representing the parameter for enabling/disabling small data transmission may be customized by operator, e.g., the operator may use term “AAAA” or “BBBB” for representing the parameter.

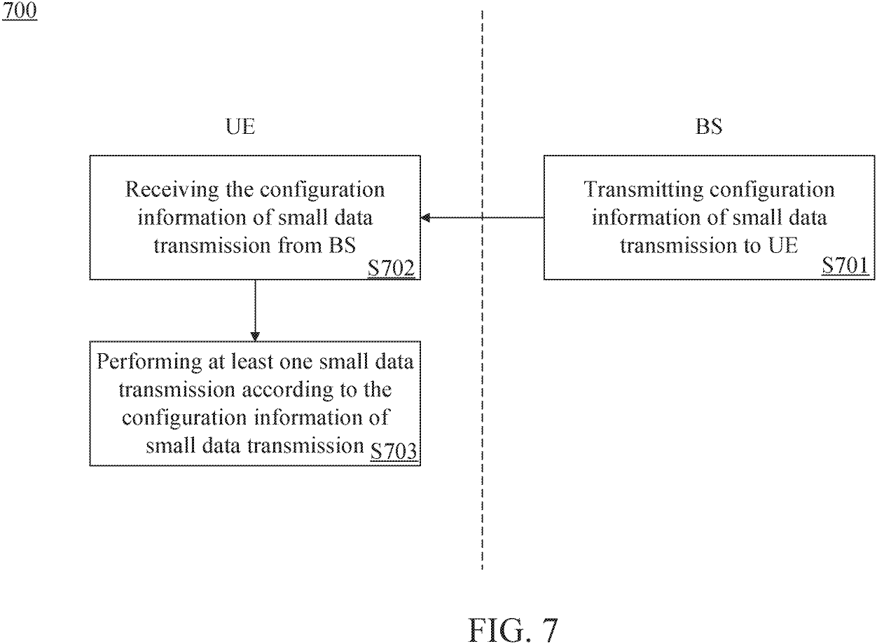

FIG. 7 illustrates a flow chart of a method for wireless communications in accordance with some embodiments of the present application. Referring to FIG. 7, method 700 is performed by a UE (e.g., UE 101) and a BS (e.g., BS 102) in some embodiments of the present application.

Operation S701 is executed to transmit, by BS, configuration information of small data transmission to UE. Operation S702 is executed to receive, by UE the configuration information from BS. Operation S703 is executed to perform, by UE, at least one small data transmission according to the configuration information of small data transmission.

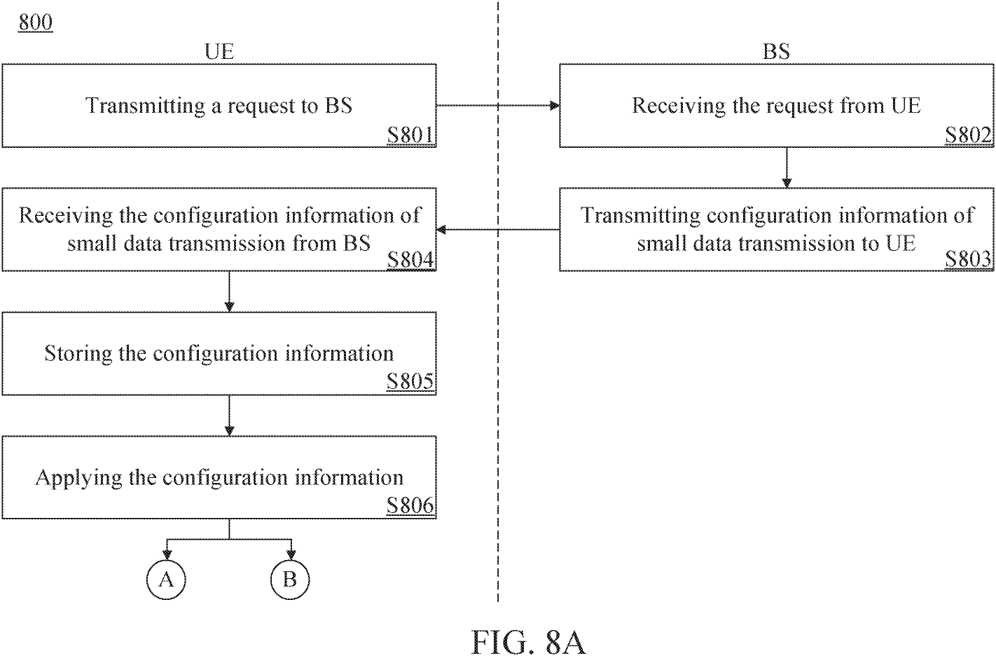

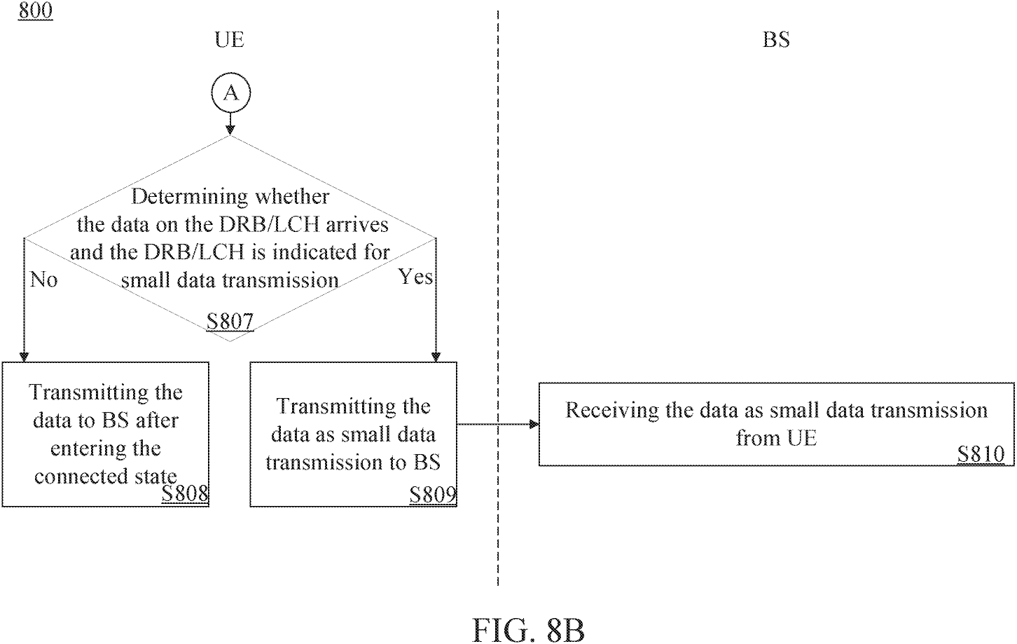

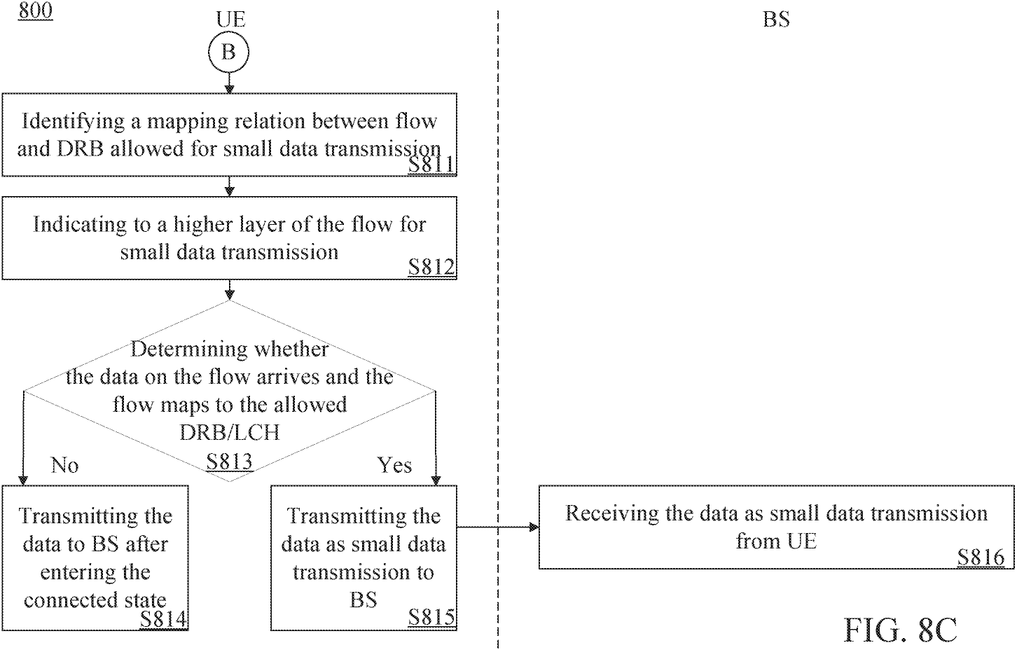

FIGS. 8A to 8C illustrate flow charts of a method for wireless communications in accordance with some embodiments of the present application. Referring to FIGS. 8A to 8C, method 800 is performed by a UE (e.g., UE 101) and a BS (e.g., BS 102) in some embodiments of the present application.

Operation S801 is executed to transmit, by UE, a request to BS for requesting configuration information for small data transmission in an inactive state. Operation S802 is executed to receive, by BS, the request from UE. Operation S803 is executed to transmit, by BS, the configuration information to UE according to the request. In some embodiments, the configuration information may indicate DRB(s)/LCH(s) for small data transmission. In some embodiments, the configuration information may further used to resume DRB(s)/LCH(s) and to indicate the resumed DRB(s)/LCH(s) for small data transmission.

Operation S804 is executed to receive, by UE, the configuration information from BS. Operation S805 is executed to store, by UE, the configuration information. In some embodiments, when UE enters the inactive state, operation S806 is executed, by UE, to apply the configuration information.

Please refer to FIG. 8B. As the perspective of user-plane, in some embodiments, operation S807 is executed to determine, by UE, whether the data on the DRB/LCH arrives and the DRB/LCH is indicated (e.g., allowed) for small data transmission. If the DRB/LCH is not configured (e.g., not allowed) for small data transmission, operation S808 is executed to transmit, by UE, the arrived data to BS after UE enters the connected state. If the data on the DRB/LCH arrives and the DRB/LCH is configured (e.g., allowed) for small data transmission, operation S809 is executed to transmit, by UE, the data as small data transmission to BS via the allowed DRB/LCH. Operation S810 is executed to receive, by BS, the arrived data as small data transmission form UE.

Please refer to FIG. 8C. As the perspective of control-plane, in some embodiments, operation S811 is executed to identify, by UE, a mapping relation between flow(s) and the DRB(s) which is (are) indicated (e.g., allowed) for small data transmission. Operation S812 is executed to indicate, by lower layer (e.g., AS layer) of UE, to a higher layer (e.g., NAS layer) of UE of the flow(s) for small data transmission.

Operation S813 is executed to determine, by UE, whether the data on the flow arrives and the flow maps to the configured DRB/LCH based on the mapping relation. If negative, operation S814 is executed to transmit, by UE, the data to BS after UE enters the connected state. If positive, operation S815 is executed to transmit, by UE, the data with another RRC message or with a higher layer (e.g., NAS layer) message as small data transmission to BS.

In some embodiments, small data transmission may be performed when a condition is satisfied. In detail, UE may determine whether a size of a MAC PDU, which is for the DRB(s) indicated to small data transmission, is not greater than a threshold. If the MAC PDU is greater than the threshold, UE may not perform small data transmission. If the MAC PDU is not greater than the threshold, UE may perform small data transmission via the allowed DRB(s).

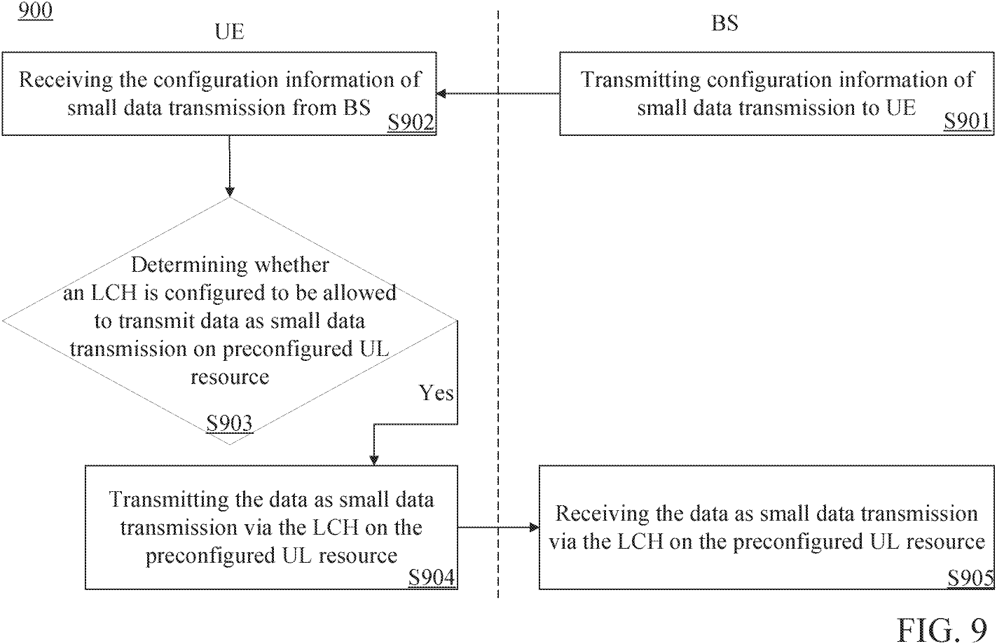

FIG. 9 illustrates a flow chart of a method for wireless communications in accordance with some embodiments of the present application. Referring to FIG. 9, method 900 is performed by a UE (e.g., UE 101) and a BS (e.g., BS 102) in some embodiments of the present application.

Operation S901 is executed to transmit, by BS, configuration information of small data transmission to UE. In some embodiments, the configuration information may indicate a restriction of selecting LCHs for each preconfigured uplink resource for small data transmission. Operation S902 is executed to receive, by UE the configuration information from BS.

Operation S903 is executed to determine, by UE, whether an LCH is configured to be allowed to transmit data as small data transmission on a preconfigured uplink resource. If positive, operation S904 is executed to transmit, by UE, the data as small data transmission to BS via the LCH on the preconfigured uplink resource. Operation S905 is executed to receive, by BS, the data as small data transmission from UE via the LCH on the preconfigured uplink resource. In some embodiments, the restriction may be configured as an LCP restriction.

In some embodiments, HARQ process may be introduced in the previous methods. In detail, UE may determine whether the data of small data transmission is successfully transmitted to BS on the preconfigured uplink resource according to HARQ process. If negative, UE may autonomously re-transmit the data of small data transmission to BS on the pre-configured uplink resource.

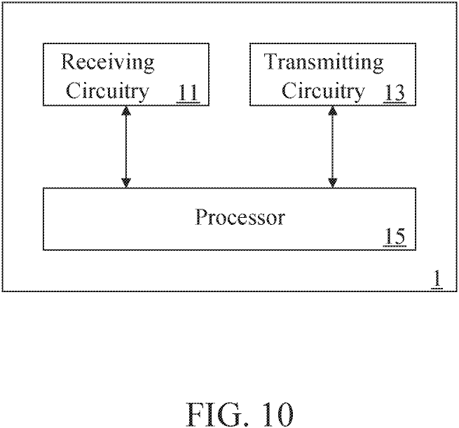

FIG. 10 illustrates an example block diagram of an apparatus 1 according to an embodiment of the present disclosure.

As shown in FIG. 10, the apparatus 1 may include at least one non-transitory computer-readable medium (not illustrated in FIG. 10), a receiving circuitry 11, a transmitting circuitry 13, and a processor 15 coupled to the non-transitory computer-readable medium (not illustrated in FIG. 10), the receiving circuitry 11 and the transmitting circuitry 13. The apparatus 1 may be a user equipment or a base station.

Although in this figure, elements such as processor 15, transmitting circuitry 13, and receiving circuitry 11 are described in the singular, the plural is contemplated unless limitation to the singular is explicitly stated. In some embodiments of the present disclosure, the receiving circuitry 11 and the transmitting circuitry 13 are combined into a single device, such as a transceiver. In certain embodiments of the present disclosure, the apparatus 1 may further include an input device, a memory, and/or other components.

In some embodiments of the present disclosure, the non-transitory computer-readable medium may have stored thereon computer-executable instructions to cause a processor to implement the method with respect to the base station as described above. For example, the computer-executable instructions, when executed, cause the processor 15 interacting with receiving circuitry 11 and transmitting circuitry 13, so as to perform the operations with respect to BS depicted in FIG. 1 to 6C.

In some embodiments of the present disclosure, the non-transitory computer-readable medium may have stored thereon computer-executable instructions to cause a processor to implement the method with respect to the user equipment as described above. For example, the computer-executable instructions, when executed, cause the processor 1 interacting with receiving circuitry 11 and transmitting circuitry 13, so as to perform the operations with respect to UE depicted in FIG. 1 to 6C .

Those having ordinary skill in the art would understand that the operations of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes”, “including”, or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a”, “an”, or the like does not, without more constraints, preclude the existence of additional identical elements in the process, method, article, or apparatus that includes the element. Also, the term “another” is defined as at least a second or more. The term “having” and the like, as used herein, are defined as “including”.

1. A method of a user equipment, comprising:
receiving configuration information of small data transmission from a base station; and
performing at least one small data transmission with the base station according to the configuration information of small data transmission.

2. The method of claim 1, further comprising:
transmitting a request to the base station for requesting the configuration information of the at least one small data transmission in an inactive state.

3. The method of claim 1, wherein the configuration information indicates at least one data radio bearer (DRB) for the at least one small data transmission.

4. The method of claim 3, wherein the configuration information further indicates to the user equipment that the at least one DRB is resumed and used for the at least one small data transmission.

5. The method of claim 3, further comprising:
storing the configuration information as a user equipment access stratum context; and
applying the configuration information when the user equipment enters an inactive mode.

6-10. (canceled)

11. The method of claim 1, wherein the configuration information indicates a restriction of selecting logical channels for each pre-configured uplink resource for the at least one small data transmission, and the method further comprises:
determining whether at least one logical channel is configured to transmit data as the at least one small data transmission via a pre-configured uplink resource.

12. (canceled)

13. The method of claim 1, further comprising:
determining that data of the at least one small data transmission is not successfully transmitted to the base station on a pre-configured uplink resource according to a hybrid automatic repeat request (HARQ) process; and
autonomously re-transmitting the data of the at least one small data transmission to the base station on the pre-configured uplink resource.

14-23. (canceled)

24. An apparatus, comprising:
a receiving circuitry;
a transmitting circuitry; and
a processor coupled to the receiving circuitry and the transmitting circuitry, configured to:
receive configuration information of small data transmission from a base station; and
perform at least one small data transmission with the base station according to the configuration information of small data transmission.

25. The apparatus of claim 24, wherein the processor coupled to the receiving circuitry and the transmitting circuitry is configured to transmit a request to the base station for requesting the configuration information of the at least one small data transmission in an inactive state.

26. The apparatus of claim 24, wherein the configuration information indicates at least one data radio bearer (DRB) for the at least one small data transmission.

27. The apparatus of claim 26, wherein the configuration information further indicates to the user equipment that the at least one DRB is resumed and used for the at least one small data transmission.

28. The apparatus of claim 24, wherein the processor coupled to the receiving circuitry and the transmitting circuitry is configured to:
store the configuration information as a user equipment access stratum context; and
apply the configuration information when the user equipment enters an inactive mode.

29. The apparatus of claim 24, wherein the configuration information indicates a restriction of selecting logical channels for each pre-configured uplink resource for the at least one small data transmission, and the processor coupled to the receiving circuitry and the transmitting circuitry is configured to determine whether at least one logical channel is configured to transmit data as the at least one small data transmission via a pre-configured uplink resource.

30. The apparatus of claim 24, wherein the processor coupled to the receiving circuitry and the transmitting circuitry is configured to:
determine that data of the at least one small data transmission is not successfully transmitted to the base station on a pre-configured uplink resource according to a hybrid automatic repeat request (HARQ) process; and
autonomously re-transmitting the data of the at least one small data transmission to the base station on the pre-configured uplink resource.

31. An apparatus, comprising:
a receiving circuitry;
a transmitting circuitry; and
a processor coupled to the receiving circuitry and the transmitting circuitry, configured to:
transmit configuration information of small data transmission to a user equipment; and
perform at least one small data transmission with the user equipment according to the configuration information of small data transmission.

32. The apparatus of claim 31, wherein the processor coupled to the receiving circuitry and the transmitting circuitry is configured to receive a request from the user equipment, wherein the request is for requesting the configuration information for the at least one small data transmission in an inactive state.

33. The apparatus of claim 31, wherein the configuration information indicates at least one data radio bearer (DRB) for the at least one small data transmission.

34. The apparatus of claim 33, wherein the configuration information further indicates to the user equipment that the at least one DRB is resumed and used for the at least one small data transmission.

35. The apparatus of claim 31, wherein the configuration information indicates a restriction of selecting logical channels for each pre-configured uplink resource for the at least one small data transmission.

36. The apparatus of claim 31, wherein the processor coupled to the receiving circuitry and the transmitting circuitry is configured to:
determine that data of the at least one small data transmission is not successfully received from the user equipment on a pre-configured uplink resource according to a hybrid automatic repeat request (HARQ) process; and
re-receive the data of the at least one small data transmission from the user equipment on the pre-configured uplink resource.
